(19) United States
(12) Patent Application Publication
(10) Pub. No.: US 2006/0242420 A1
(43) Pub. Date: Oct. 26, 2006

(54) Electronic cable release coupled with portable computer screensaver

(76) Inventors: Herman Rodriguez, Austin, TX (US); Michael P. Carlson, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/111,525

(22) Filed: Apr. 21, 2005

(51) Int. Cl. H04L 9/00

(52) U.S. Cl. 713/182

(57) ABSTRACT

Controlling the actuation of a security latch for attaching a computer to a retaining member is useful in physically protecting a computer from theft. A protruding element is inserted into computer housing while pressing a control arm to disengage a locking arm. The present invention allows the security latch to be controlled by computer software via a solenoid in the security latch system. The security latch system of the present invention detects an input code identifying a user input to the inactive computer and is activated by said user input. The security latch is released in response to said input code for a predetermined time period during which said computer may be removed from the retaining member.

### TECHNICAL FIELD

The present invention relates to a computer system that controls the actuation of a security latch, and particularly to desktop locking software related to disengaging a cable retention arm connected to a portable computer.

### BACKGROUND OF RELATED ART

In the current art relating to physical protection of portable computers, a steel cable and a padlock are usually required. Such current protection systems comprise either a padlock that is a combination lock, or a padlock that has a combination lock attached. A protruding element is inserted into the portable computer housing while pressing a control arm to disengage a locking arm, which is similarly engaged by pressing the control arm to release the protruding element from the computer housing. Presently, portable computer software lacks the awareness of whether its corresponding system is physically protected. Also, the current art does not allow for remote release of the cable lock, and requires the disclosure of the same combination code to all users that need to move the inherent portable computer. Further, the current art requires a user to memorize the code sequence to operate the physical protection system.

### SUMMARY OF THE PRESENT INVENTION

The present invention provides a method for controlling the actuation of a security latch for attaching a computer to a retaining member. This invention detects an input code identifying a user input to an inactive computer and activates computer responsive to an input code identifying an authorized user. The present invention is responsive to said input code identifying said authorized user and releases said security latch for a predetermined time period during which said computer may be removed from said retaining member.

The present invention also identifies a computer administrator by detecting an input code, and is responsive to said input code identifying said computer administrator. The invention then releases the security latch for an unlimited time period.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system on which the present invention for controlling the actuation of a security latch may be practiced;

FIG. 2 is a diagram of a security latch of the present invention;

FIG. 3 is an illustrative flowchart describing the setting up of the elements needed for the program for controlling the actuation of a security latch of the present invention; and

FIG. 4 is a flowchart of an illustrative run of the program set up in FIG. 3.

### DETAILED DESCRIPTION OF THE PREFERRED EMBODIMENT

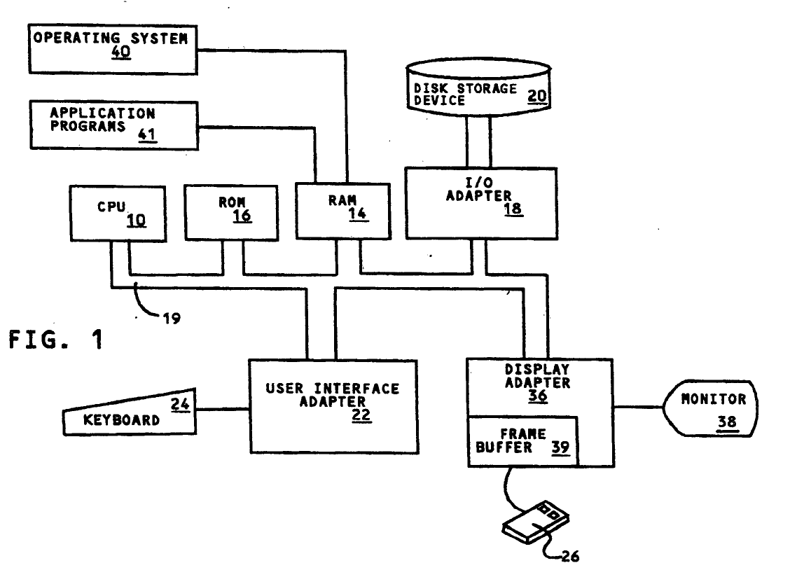

Referring to FIG. 1, a generalized system is shown which may function as a basic data processing system on which the present invention may be implemented. A CPU 10 is provided and interconnected to various other components by system bus 19. An operating system 40 runs on a CPU 10, provides control and is used to coordinate the functions of the various components of FIG. 1. Operating system 40 may be one of the commercially available operating systems which is capable of handling multiprocessing, such as IBM's AIX 6000™ operating system or the OS/2™ operating system available from IBM, Microsoft's Windows NT™, as well as other UNIX and AIX operating systems. The operating system is in random access memory (RAM) 14 during the system operations. Application programs 41 controlled by the system are moved into and out of the main memory, RAM 14.

The system shown in FIG. 1 also includes the following conventional elements. A read only memory (ROM) 16 is connected to CPU 10 via system bus 19 and includes the basic input/output system (BIOS) that controls the basic computer functions. RAM 14 and I/O adapter 18 are also interconnected to system bus 19. I/O adapter 18 may be a small computer system interface (SCSI) adapter that communicates with the disk storage device 20. I/O devices are also connected to system bus 19 via user interface adapter 22 and display adapter 36. Keyboard 24 and mouse 26 are all interconnected to bus 19 through user interface adapter 22. It is through such input devices that the user may interactively relate to a browser and other related programs according to the present invention. Display adapter 36 includes a frame buffer 39, which is a storage device that holds a representation of each pixel on the display screen of the monitor 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

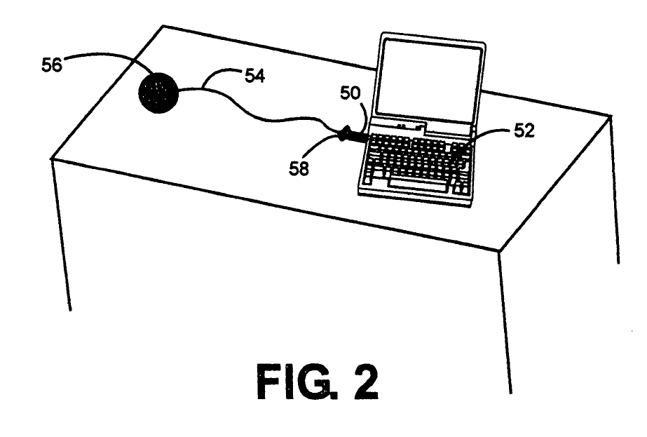

With reference to FIG. 2, an illustration of the security latch of the present invention is shown. FIG. 2 shows the security latch 50 attached to a portable computer 52. The security latch 50 comprises means for attaching a computer to a retaining member 56, such as a desk, via a security cable 54. The security cable 54 comprises a steel cable, a first end of the cable having a protruding locking arm for attaching the cable to a computer 52, and a second end of the cable having attaching means for attaching the cable to a retaining member 56. The security latch 50 further comprises a ratchet locking mechanism. The ratchet locking mechanism comprises means for inserting the security cable locking arm 58 into the security latch 50 locking the security cable 54 into the security latch 50. Once inserted into the security latch 50, the security cable locking arm 58 cannot be removed unless the security latch 50 is released. The ratchet locking mechanism further comprises means for releasing the security latch 50, and means for removing the security cable locking arm 58, allowing the removal of the computer 52 from the retaining member 56.

The security latch 50 of the present invention shown in FIG. 2 is actuated via a small solenoid housed within the security latch system. A solenoid is an electromagnetic device that converts electrical energy to mechanical movement. The solenoid of the present invention is coupled with an input/output controller and is engaged on demand from the software, and disengages the cable locking arm 58 of the security latch 50. Activation of the solenoid releases the security latch 50 for a specified period of time. The period of time can be set with an apparatus such as a spring tension release, a microcontrolled actuator, or the like, or it can be further controlled via computer hardware or software or a combination of both. When the screensaver lock in the software of the portable computer 52 is deactivated, the security latch 50 is automatically disengaged for a period of time, allowing release of the security cable 54. The security latch system of the present invention further comprises a bypass apparatus attached to solenoid terminals to control release of the security latch 50 when the system is inoperative. The bypass apparatus can release the security latch 50 for as long as the bypass apparatus is in place. The solenoid terminals are accessible only from within the computer casing. Other C2 security mechanisms can be used to detect physical intrusion of the computer casing.

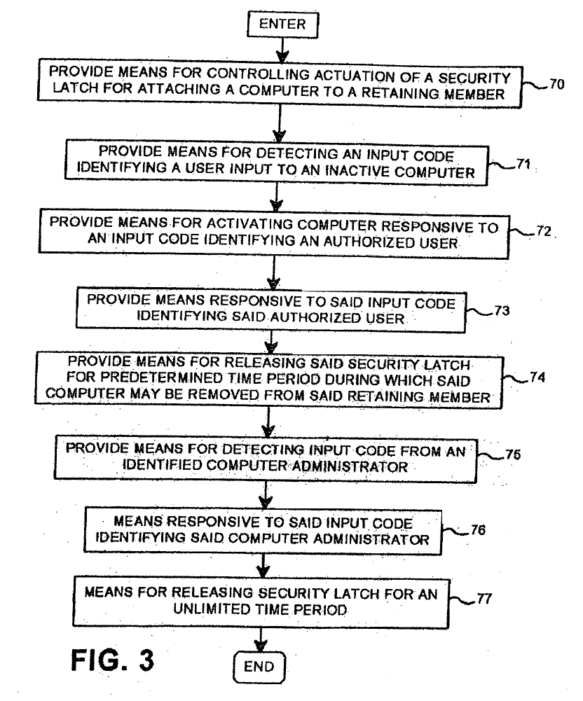

FIG. 3 is a flowchart showing the development of a process according to the present invention for controlling the actuation of a security latch for attaching a computer to a retaining member. A “screensaver” is defined as a utility that causes a monitor to blank out or display a certain image after a specified amount of time passes without the keyboard being touched or the mouse being moved. Touching a key or moving the mouse deactivates the screensaver. Means are provided for controlling actuation of a security latch for attaching a computer to a retaining member, step 70. In the present invention, the computer can be activated by deactivating its screensaver. A computer screensaver actuates the locking of the solenoid that controls the security latch. Computer users have option of selecting the enabling the release of the security latch via user profiles. Entering the password setting for deactivating a screensaver locking mechanism can also release the security latch, allowing for removal of the computer. The screensaver software automatically disengages the computer security latch based on user ID privileges.

FIG. 3 further provides means for detecting an input code identifying a user input to an inactive computer, step 71. Means are provided for activating computer responsive to an input code identifying an authorized user, step 72. For authorized users, the screensaver software automatically releases the security latch when the screensaver password deactivates the screensaver locking mechanism. For unauthorized users, the screensaver software does not release the security latch. Means are provided responsive to said input code identifying said authorized user, step 73. Means are provided for releasing said security latch for predetermined time period during which said computer may be removed from said retaining member, step 74. The computer can be a laptop computer, a PDA, a desktop, or the like.

Also in FIG. 3, means are provided for detecting input code from an identified computer administrator, step 75. Means are provided responsive to said input code identifying said computer administrator, step 76. Means are provided for releasing security latch for an unlimited time period, step 77. The security latch of the present invention can be reset to its closed “locked” position by mechanical means, e.g. a spring tension, or can be computer controlled or electric mechanical means via a timer. The security latch system of the present invention further comprises a bypass apparatus attached to solenoid terminals to control release of the security latch when the system is inoperative. The bypass apparatus can release the security latch for as long as the bypass apparatus is in place. The solenoid terminals are accessible only from within the computer casing. Other C2 security mechanisms can be used to detect physical intrusion of the computer casing.

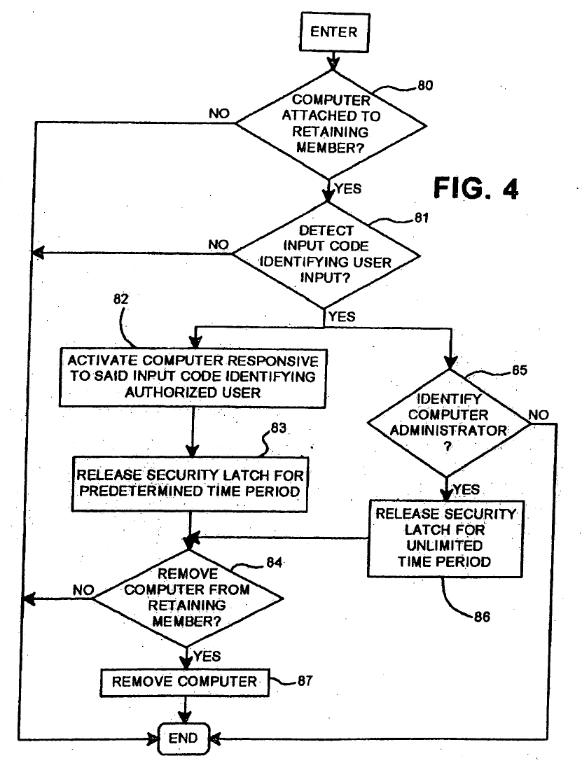

A simplified run of the process set up in FIG. 3 will now be described with respect to the flowchart of FIG. 4. First, a determination is made regarding whether a computer is attached to a retaining member, step 80. If No, the process ends. If Yes, a determination is made regarding whether input code is detected identifying user input, step 81. If No, the process ends. If Yes, the computer is activated responsive to said input code identifying said authorized user, step 82, and the security latch is released to its open position for a predetermined time period, step 83. Alternatively, after the input code is detected identifying user input from step 81, a determination can be made regarding whether computer administrator has been identified, step 85. If No, the process ends. If Yes, the security latch is released for an unlimited time period, step 86. A determination is then made following steps 83 and 86 regarding whether to remove the computer from the retaining member, step 84. If No, the process ends. If Yes, the computer is removed, step 87.

One of the preferred implementations of the present invention is an application program 41 made up of programming steps or instructions resident in RAM 14, FIG. 1, during computer operations. Until required by the computer system, the program instructions may be stored in another readable medium, e.g. disk drive 20, or in a removable memory such as an optical disk for use in a CD ROM computer input or in a floppy disk for use in a floppy disk drive computer input. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. A method for controlling the actuation of a security latch for attaching a computer to a retaining member comprising:
detecting an input code identifying a user input to an inactive computer;
activating computer responsive to an input code identifying an authorized user;
responsive to said input code identifying said authorized user; and
releasing said security latch for predetermined time period during which said computer may be removed from said retaining member.

2. The method of claim 1 further including the steps of:
detecting an input code;
identifying a computer administrator;
responsive to said input code identifying said computer administrator; and
releasing security latch for an unlimited time period.

3. The method of claim 1 wherein the computer is activated by deactivating its screensaver and wherein password settings for deactivating the screensaver releases the security latch allowing removal of the computer from the retaining member.

4. The method of claim 3 wherein the computer is a laptop computer.

5. The method of claim 3 wherein the computer is a Personal Digital Assistant (PDA).

6. The method of claim 3 wherein the computer is a desktop.

7. The method of claim 3 wherein the security latch is released via a timer.

8. A system for controlling the actuation of a security latch for attaching a computer to a retaining member comprising:
means for detecting an input code identifying a user input to an inactive computer;
means for activating computer responsive to an input code identifying an authorized user;
means responsive to said input code identifying said authorized user; and
means for releasing said security latch for predetermined time period during which said computer may be removed from said retaining member.

9. The system of claim 8 further including the steps of:
means for detecting an input code;
means for identifying a computer administrator;
means responsive to said input code identifying said computer administrator; and
means for releasing security latch for an unlimited time period.

10. The system of claim 9 wherein the security latch comprises:
means for attaching a computer to a retaining member via a security cable, the security cable comprising:
a steel cable;
a first end of the cable having a protruding locking arm for attaching the cable to a computer; and
a second end of the cable having attaching means for attaching the cable to a retaining member.

11. The system of claim 10 wherein the security latch further comprises a ratchet locking mechanism, the ratchet locking mechanism comprising:
means for inserting the security cable locking arm into the security latch locking the security cable into the security latch;
means for releasing the security latch; and
means for removing the security cable locking arm.

12. The system of claim 11 wherein the security latch further comprises a solenoid coupled with an input/output controller.

13. The system of claim 12 wherein activation of the solenoid releases the security latch.

14. The system of claim 13 further comprising a bypass apparatus to control release of the security latch when the system is inoperative.

15. A computer program having code recorded on a computer readable medium for controlling the actuation of a security latch for attaching a computer to a retaining member comprising:
detecting an input code identifying a user input to an inactive computer;
activating computer responsive to an input code identifying an authorized user;
responsive to said input code identifying said authorized user; and
releasing said security latch for predetermined time period during which said computer may be removed from said retaining member.

16. The computer program of claim 15 further including the steps of:
detecting an input code;
identifying a computer administrator;
responsive to said input code identifying said computer administrator; and
releasing security latch for an unlimited time period.

17. The computer program of claim 16 wherein the computer is activated by deactivating its screensaver.

18. The computer program of claim 17 wherein password settings for deactivating the screensaver locking mechanism release the security latch allowing removal of the computer from the retaining member.

19. The computer program of claim 18 wherein the security latch is released via a timer.

20. The computer program of claim 19 further comprising a bypass apparatus to control release of the security latch when the system is inoperative.
